(19) United States
(12) Patent Application Publication
(10) Pub. No.: US 2009/0075001 A1
(43) Pub. Date: Mar. 19, 2009

(54) Flushable toilet paper roll (FTPR)

(76) Inventor: Tom O'Neill, (US)

Correspondence Address: Tom O'neill, 2200 S. FORT APACHE RD. # 1004, LAS VEGAS, NV, 89117, US

(21) Appl. No.: 11/901,736

(22) Filed: Sep. 19, 2007

(51) Int. Cl. B32B 1/08

(52) U.S. Cl. 428/35.7

(57) ABSTRACT

The Flushable Toilet Paper Roll (FTPR) is new in the art of toilet paper dispense. It holds the same shape as a traditional cardboard toilet paper roll but when the toilet paper is exhausted the FTPR is easily disposed of by placing in the toilet's water and flushed. It is dissolves quickly when placed in the water and is completely environmentally friendly. It is comprised of cornstarch (or similar material).

### CROSS-REFERENCE TO RELATED APPLICATIONS

N/A

### STATEMENT REGARDING FEDERALLY SPONSORED RESEARCH OR DEVELOPMENT

N/A

### REFERENCE TO SEQUENCE LISTING, A TABLE, OR A COMPUTER PROGRAM LISTING COMPACT DISC APPENDIX

N/A

### BACKGROUND OF THE INVENTION

The FTPR is designed to reduce the amount of solid waste that is produced in conjunction with humans using the restroom. By quickly dissolving when placed into water, the FTPR eliminates the accumulation of cardboard waste when the toilet paper on the roll is exhausted.

### BRIEF SUMMARY OF THE INVENTION

The Flushable Toilet Paper Roll (FTPR) is designed to quickly dissolve when placed in water leaving behind no toxic waste. Composed of corn starch (or similar material), the FTPR is completely water soluble and bio-friendly.

Manufacture of the FTPR is similar to the traditional methods of rolling the cardboard in a normal toilet paper roll but a great advantage is that the FTPR is also capable of being manufactured in a cast or with one seam.

### BRIEF DESCRIPTION OF THE SEVERAL VIEWS OF THE DRAWINGS

FIG. 1

FIG. 1 shows the profile view of the FTPR. Note that the dimensions are the same as many cardboard manufactured rolls.

FIG. 2

FIG. 2 shows the “head-on” view of the FTPR. Note that the diameter is the same as many cardboard manufactured rolls.

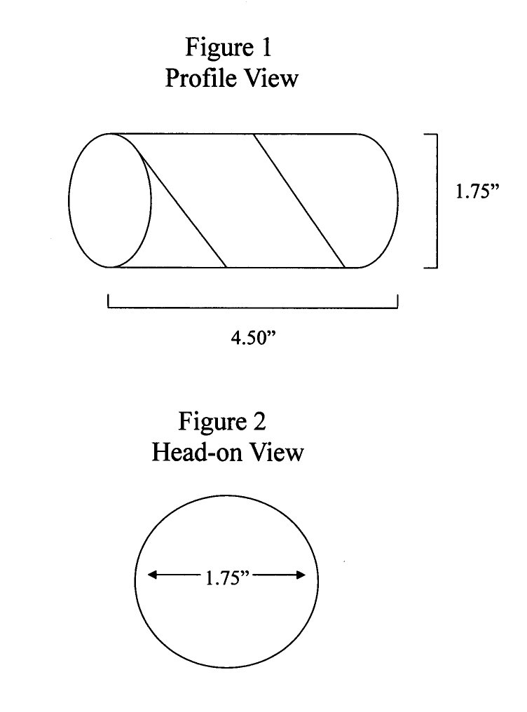

### DETAILED DESCRIPTION OF THE INVENTION

The Flushable Toilet Paper Roll (FTPR) is comprised of cornstarch (or similar material) and is designed to quickly dissolve when placed in water. Completely environmentally friendly, the FTPR reduces the amount of solid waste produced in the bathroom.

The FTPR is manufactured in the same manner as traditional cardboard toilet paper rolls but is also able to be produced with a cast or with a single horizontal seam.

1. It is the claim that the Flushable Toilet Paper Roll (FTPR) is a new invention. The FTPR is made of cornstarch (or similar material) and has several ways of being manufactured.
